(19) United States
(12) Patent Application Publication
(10) Pub. No.: US 2026/0177388 A1
(43) Pub. Date: Jun. 25, 2026

(54) SYSTEMS AND METHODS FOR OPTIMIZING ROUTES FOR VEHICLES

(71) Applicant: HERE GLOBAL B.V., EINDHOVEN (NL)

(72) Inventors: JEROME BEAUREPAIRE, NANTES (FR); JEREMY MICHAEL YOUNG, BEVERLY HILLS, MI (US)

(73) Assignee: HERE GLOBAL B.V., EINDHOVEN (NL)

(21) Appl. No.: 18/989,556

(22) Filed: Dec. 20, 2024

(51) Int. Cl. G01C 21/34

(52) U.S. Cl. CPC G01C 21/3469

(57) ABSTRACT

Systems and methods for optimizing routes for vehicles are provided. For example, a method for optimizing routes for vehicles includes receiving electric vehicle charging constraints of one or more vehicles. The method also includes receiving information corresponding to one or more navigation constraints associated with the one or more vehicles. The method also includes determining a route that satisfies the electric vehicle charging constraints of the one or more vehicles and at least one of the one or more navigation constraints associated with the one or more vehicles. The method also includes providing the route to the one or more vehicles.

### TECHNICAL FIELD

The present disclosure relates generally to routing, and more specifically to systems and methods for optimizing routes for vehicles.

### BACKGROUND

Maps have been used for centuries for providing route geometry and geographical information. Conventional paper maps including static images of roadways and geographic features from a snapshot in history have given way to digital maps presented on computers and mobile devices. Navigating a network of roads is made easier through maps, and particularly digital maps which enable a user to view their location on a map while navigating the roads. Further, route guidance may be provided by navigation systems for a use to navigate through the network of roads to reach a destination. Typically, route guidance may be provided to a user according to the shortest distance to a destination, or a fastest time to a destination. However, there is no optimal way of optimizing routes for vehicles travelling along together.

### BRIEF SUMMARY

The present disclosure overcomes the shortcomings of prior technologies. In particular, a novel approach for optimizing routes for vehicles is provided, as detailed below.

In accordance with an aspect of the disclosure, a method for optimizing routes for vehicles. The method includes receiving electric vehicle charging constraints of one or more vehicles. The method also includes receiving information corresponding to one or more navigation constraints associated with one or more vehicles. The method also includes determining a route that satisfies the electric vehicle charging constraints of the one or more vehicles and at least one of the one or more navigation constraints associated with the one or more vehicles. The method also includes providing the route to the one or more vehicles.

In accordance with another aspect of the present disclosure, a non-transitory computer-readable storage medium is provided. The non-transitory computer-readable storage medium includes one or more sequences of one or more instructions for execution by one or more processors of an apparatus. The one or more instructions which, when executed by the one or more processors, cause the apparatus to perform the step of receiving electric vehicle charging constraints of one or more vehicles. The one or more instructions further cause the apparatus to perform the step of receiving information corresponding to one or more navigation constraints associated with the one or more vehicles. The one or more instructions further cause the apparatus to perform the step of determining a route that satisfies the electric vehicle charging constraints of the one or more vehicles and at least one of the one or more navigation constraints associated with the one or more vehicles. The one or more instructions further cause the apparatus to perform the step of providing the route to the one or more vehicles.

In accordance with another aspect of the disclosure, a system for optimizing routes for vehicles is provided. The system includes at least one processor and at least one non-transitory memory including computer program code instructions. The computer program code instructions which, when executed, cause the system to receive electric vehicle charging constraints of one or more vehicles. The computer program code instructions further cause the system to receive information corresponding to one or more navigation constraints associated with the one or more vehicles. The computer program code instructions further cause the system to determine a route that satisfies the electric vehicle charging constraints of the one or more vehicles and at least one of the one or more navigation constraints associated with the one or more vehicles. The computer program code instructions further cause the system to provide the route to the one or more vehicles.

In addition, for various example embodiments, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment.

For various example embodiments, the following is also applicable: a method comprising facilitating access to at least one interface configured to allow access to at least one service, the at least one service configured to perform any one or any combination of network or service provider methods (or processes) disclosed in this application.

For various example embodiments, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment, and/or at least one signal resulting from one or any combination of methods (or processes) disclosed in this application as relevant to any embodiment.

For various example embodiments, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment, and/or at least one signal resulting from one or any combination of methods (or processes) disclosed in this application as relevant to any embodiment.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of the claims.

Still other aspects, features, and advantages are readily apparent from the following detailed description, simply by illustrating a number of particular embodiments and implementations. The drawings and description are to be regarded as illustrative in nature, and not as restrictive.

### BRIEF DESCRIPTION OF THE DRAWINGS

The embodiments are illustrated by way of example, and not by way of limitation, in the figures of the accompanying drawings:

FIG. 1 is a diagram of a system capable of optimizing routes for vehicles, in accordance with aspects of the present disclosure;

FIG. 2 is a diagram of the components of a data analysis system, in accordance with aspects of the present disclosure;

FIG. 3 is a flowchart setting forth steps of an example process, in accordance with aspects of the present disclosure;

FIG. 4 is a diagram of a geographic database, in accordance with aspects of the present disclosure;

FIG. 5 is a diagram of an example computer system, in accordance with aspects of the present disclosure;

FIG. 6 is a diagram of an example chip set, in accordance with aspects of the present disclosure; and

FIG. 7 is a diagram of an example mobile device, in accordance with aspects of the present disclosure.

### DESCRIPTION OF SOME EMBODIMENTS

Various embodiments of methods, systems, and non-transitory computer-readable storage mediums for optimizing routes for vehicles are disclosed. In the following description, for the purposes of explanation, numerous specific details are set forth in order to provide a thorough understanding of the embodiments. It is apparent, however, to one skilled in the art that the embodiments may be practiced without these specific details or with an equivalent arrangement. In other instances, well-known structures and devices are shown in block diagram form in order to avoid unnecessarily obscuring the embodiments.

In various embodiments, a system for optimizing routes for vehicles is configured to receive electric vehicle charging constraints of one or more vehicles and information corresponding to one or more navigation constraints associated with the passengers of the one or more vehicles to enable two or more vehicles to travel together along a route. In various embodiments, the system is configured to organize and plan the route for all the vehicles involved. In various embodiments, the system is configured to adapt the plan in real-time and adjust based on one or more changes while the two or more vehicles are travelling together along the route. In one example, the changes on the road may be related to changes requested by one or more individuals of the two or more vehicles. In another example, the changes may be based on events that occur at various times while the two or more vehicles are travelling together along the route.

In various embodiments, the system may be configured to achieve various goals associated with the individuals of the two or more vehicles. In various embodiments, the system is configured to receive information from the individuals about the various goals to be achieved. For example, one or more of the following may be selected, driving together all the way, arriving together at the same time, stopping for lunch together, stopping for all or some breaks togethers, having one vehicle arrive earlier at the destination, etc.

In various embodiments, the system is configured to optime the route for each of the vehicles based on specific criteria associated with each vehicle. For example, if the vehicles have different starting points, the system could determine the route that would need to be taken by a first vehicle to meet up with the second vehicle at either a fixed location (e.g., an address) or a dynamic location (e.g., within two or more distance markers) along the route. In another example, the system is configured to determine the route that would need to be taken by both vehicles if each of the vehicles have a different destination. In another example, the system is configured to determine the route that each vehicle would need to take based on different starting points and different destinations. In this example, the system may be configured to maximize the amount of time that each vehicle spends together along one or more portions of a shared route.

In various embodiments, the system is configured to optimize the route for two or more electric vehicles. In various embodiments, the system is configured to optimize the route for at least one electric vehicle and at least one vehicle with an internal combustion engine. In one example where one of the vehicles is an electric vehicle and the other vehicle has an internal combustion engine, the system is configured to suggest locations for refueling and recharging that include stations that are suitable for both types of vehicles. In another example, the system is configured to provide different locations for refueling and recharging based on the types of electric vehicle charge points that are available along the route. In another example, the system is configured to provide electric vehicle charge points that could be utilized for charging that are also nearby restaurants as a way to combine activities along the route.

In various embodiments, the system is configured to determine an optimal use of the two or more vehicles for optimizing the route. For example, the system may provide recommendations related to the optimal placement of passengers or luggage in each of the vehicles to minimize the number of stops needed. In this example, the system is configured to analyze the charging profiles and operating parameters of each of the vehicles in order to provide recommendations for loading the vehicles and not requiring additional stops to recharge one or more of the vehicles.

In various embodiments, the system is configured to receive a selection or automatically select a lead vehicle of the two or more vehicles. In various embodiments, the system is configured to prioritize the requirements of the lead vehicle. By way of example, the system may select a lead vehicle that has the shortest range. In this example, this would ensure that the other vehicles do not leave the vehicle with the shortest range behind when travelling along the route.

In various embodiments, the system is configured to receive real-time position information of the two or more vehicles travelling along a route. In various embodiments, the system is configured to receive the remaining range of each of the two or more vehicles travelling along a route. In various embodiments, the system is configured to receive the next planned stops for each of the two or more vehicles travelling along a route. In one example, if one vehicle decides to stop at a location along the route and the second vehicle continues travelling along the route, then the system could be configured to determine the next time and location along the route where both vehicles can meet up again based on various conditions associated with each vehicle. In one example, the system could be configured to provide recommendations to each vehicle so that two vehicles can meet up again. For example, the system may be configured to recommend that one vehicle make a stop to allow a second vehicle to come within a predetermined proximity of the location of the first vehicle. In another example, the system may be configured to recommend a reduction in speed in one of the vehicles until the other vehicle is within a predetermined proximity. In various embodiments, the system is configured to consider multiple factors (e.g., traffic, weather, events, points of interest, emergencies breaks, distance to next electric vehicle charge point, etc.) for optimizing the route for the vehicles.

In various embodiments, the system is configured to create a travel plan and take into consideration that individuals associated with each of the vehicles may have different routing parameters or preferences. For example, an individual in a first vehicle may prefer to avoid highways while an individual in a second vehicle may prefer to avoid highways at night. In this example, the system is configured to optime part of a route that allows for the second vehicle to use a highway during the day and has both vehicles travelling together via local roads along a different part of the route at night. In various embodiments, the system is configured to compute a combined estimated time of arrival (ETA) which takes into consideration each of the vehicle's statuses and constraints (e.g., battery charge level, range remaining, etc.). In one example, the system is configured to provide the combined ETA to each of the vehicles. In one scenario, the combined ETA could be displayed in one or more displays associated with each vehicle.

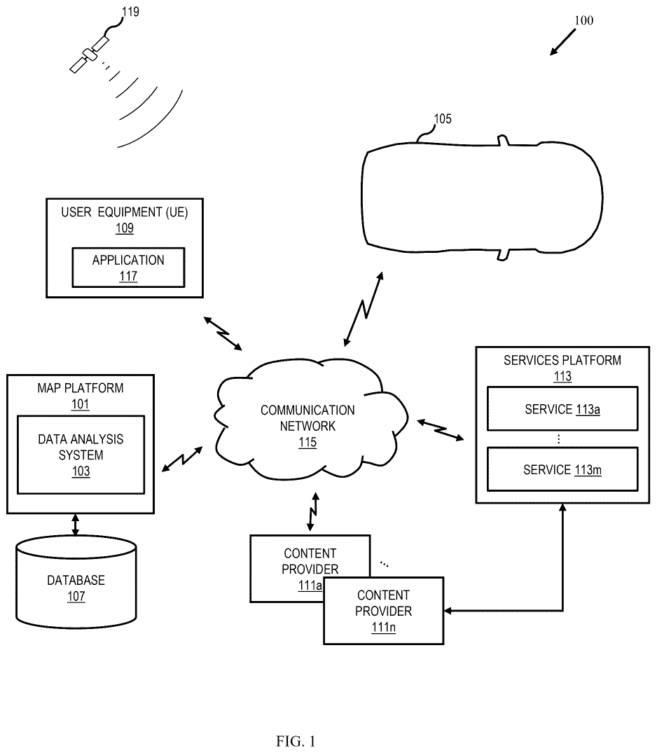

FIG. 1 provides a diagram of an example system that can be used in conjunction with various embodiments for optimizing routes for vehicles. Referring to FIG. 1, the map platform 101 of the system 100 can be a standalone server or a component of another device with connectivity to the communication network 115. For example, the component can be part of an edge computing network where remote computing devices (not shown) are installed along or within proximity of a given geographical area.

The communication network 115 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, fifth generation mobile (5G) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the map platform 101 may be a platform with multiple interconnected components. The map platform 101 may include multiple servers, intelligent networking devices, computing devices, components and corresponding software for generating information for optimizing routes for vehicles or other map functions. In addition, it is noted that the map platform 101 may be a separate entity of the system 100, a part of one or more services 113a-113m of a services platform 113.

The services platform 113 may include any type of one or more services 113a-113m. By way of example, the one or more services 113a-113m may include weather services, mapping services, navigation services, travel planning services, notification services, social networking services, content (e.g., audio, video, images, etc.) provisioning services, application services, storage services, information for optimizing routes for vehicles, location-based services, news services, etc. In one embodiment, the services platform 113 may interact with the map platform 101, and/or one or more content providers 111a-111n to provide the one or more services 113a-113m.

In one embodiment, the one or more content providers 111a-111n may provide content or data to the map platform 101, and/or the one or more services 113a-113m. The content provided may be any type of content, mapping content, textual content, audio content, video content, image content, etc. In one embodiment, the one or more content providers 111a-111n may provide content that may aid in optimizing routes for vehicles according to the various embodiments described herein. In one embodiment, the one or more content providers 111a-111n may also store content associated with the map platform 101, and/or the one or more services 113a-113m. In another embodiment, the one or more content providers 111a-111n may manage access to a central repository of data, and offer a consistent, standard interface to data.

In one embodiment, the vehicle 105 may be a hybrid vehicle, an electric vehicle, and/or any other mobility implement type of vehicle. The vehicle 105 includes parts related to mobility, such as a powertrain with an engine, a transmission, a suspension, a driveshaft, and/or wheels, etc. In another example, the vehicle 105 may be an autonomous vehicle. The autonomous vehicle may be a manually controlled vehicle, semi-autonomous vehicle (e.g., some routine motive functions, such as parking, are controlled by the vehicle), or an autonomous vehicle (e.g., motive functions are controlled by the vehicle without direct driver input).

The autonomous level of a vehicle can be a Level 0 autonomous level that corresponds to no automation for the vehicle, a Level 1 autonomous level that corresponds to a certain degree of driver assistance for the vehicle, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle. In one embodiment, user equipment (e.g., a mobile phone, a portable electronic device, etc.) may be integrated in the vehicle, which may include assisted driving vehicles such as autonomous vehicles, highly assisted driving (HAD), and advanced driving assistance systems (ADAS). Any of these assisted driving systems may be incorporated into the user equipment. Alternatively, an assisted driving device may be included in the vehicle.

The term autonomous vehicle may refer to a self-driving or driverless mode in which no passengers are required to be on board to operate the vehicle. An autonomous vehicle may be referred as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate and respond to lane marking indicators (lane marking type, lane marking intensity, lane marking color, lane marking offset, lane marking width, or other characteristics) and driving commands or navigation commands.

In one embodiment, the vehicle 105 may be an HAD vehicle or an ADAS vehicle. An HAD vehicle may refer to a vehicle that does not completely replace the human operator. Instead, in a highly assisted driving mode, the vehicle may perform some driving functions and the human operator may perform some driving functions. Vehicles may also be driven in a manual mode in which the human operator exercises a degree of control over the movement of the vehicle. The vehicles may also include a completely driverless mode. Other levels of automation are possible. The HAD vehicle may control the vehicle through steering or braking in response to the position of the vehicle and may respond to lane marking indicators (lane marking type, lane marking intensity, lane marking color, lane marking offset, lane marking width, or other characteristics) and driving commands or navigation commands. Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) and driving commands or navigation commands.

In one embodiment, the user equipment (UE) 109 may be, or include, an embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 109 may support any type of interface with a user (e.g., by way of various buttons, touch screens, consoles, displays, speakers, “wearable” circuitry, and other I/O elements or devices). Although shown in FIG. 1 as being separate from the vehicle 105, in some embodiments, the UE 109 may be integrated into, or part of, the vehicle 105.

In one embodiment, the UE 109, may execute one or more applications 117 (e.g., software applications) configured to carry out steps in accordance with methods described here. For instance, in one non-limiting example, the application 117 may carry out steps for optimizing routes for vehicles. In another non-limiting example, application 117 may also be any type of application that is executable on the UE 109 and/or vehicle 105, such as autonomous driving applications, mapping applications, location-based service applications, navigation applications, content provisioning services, camera/imaging application, media player applications, social networking applications, calendar applications, and the like. In yet another non-limiting example, the application 117 may act as a client for the data analysis system 103 and perform one or more functions associated with optimizing routes for vehicles, either alone or in combination with the data analysis system 103.

In some embodiments, the UE 109, and/or the vehicle 105 may include various sensors for acquiring a variety of different data or information. For instance, the UE 109, and/or the vehicle 105 may include one or more camera/imaging devices for capturing imagery (e.g., terrestrial images), global positioning system (GPS) sensors or Global Navigation Satellite System (GNSS) sensors for gathering location or coordinates data, network detection sensors for detecting wireless signals, receivers for carrying out different short-range communications (e.g., Bluetooth, Wi-Fi, Li-Fi, near field communication (NFC) etc.), temporal information sensors, Light Detection and Ranging (LIDAR) sensors, Radio Detection and Ranging (RADAR) sensors, audio recorders for gathering audio data, velocity sensors, switch sensors for determining whether one or more vehicle switches are engaged, and others.

The UE 109, and/or the vehicle 105 may also include one or more light sensors, height sensors, accelerometers (e.g., for determining acceleration and vehicle orientation), magnetometers, gyroscopes, inertial measurement units (IMUs), tilt sensors (e.g., for detecting the degree of incline or decline), moisture sensors, pressure sensors, and so forth. Further, the UE 109, and/or the vehicle 105 may also include sensors for detecting the relative distance of the vehicle 105 from a lane or roadway, the presence of other vehicles, pedestrians, traffic lights, lane markings, speed limits, road dividers, potholes, and any other objects, or a combination thereof. Other sensors may also be configured to detect weather data, traffic information, or a combination thereof. Yet other sensors may also be configured to determine the status of various control elements of the car, such as activation of wipers, use of a brake pedal, use of an acceleration pedal, angle of the steering wheel, activation of hazard lights, activation of head lights, and so forth.

In some embodiments, the UE 109, and/or the vehicle 105 may include GPS, GNSS or other satellite-based receivers configured to obtain geographic coordinates from a satellite 119 for determining current location and time. Further, the location can be determined by visual odometry, triangulation systems such as A-GPS, Cell of Origin, or other location extrapolation technologies, and so forth. In some embodiments, two or more sensors or receivers may be co-located with other sensors on the UE 109, and/or the vehicle 105.

By way of example, the map platform 101, the services platform 113, and/or the one or more content providers 111a-111n communicate with each other and other components of the system 100 using well known, new or still developing protocols. In this context, a protocol includes a set of rules defining how the network nodes within the communication network 115 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6, and layer 7) headers as defined by the OSI Reference Model.

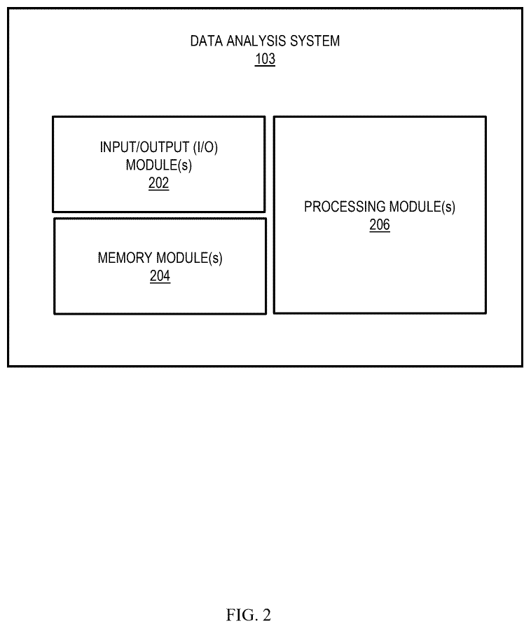

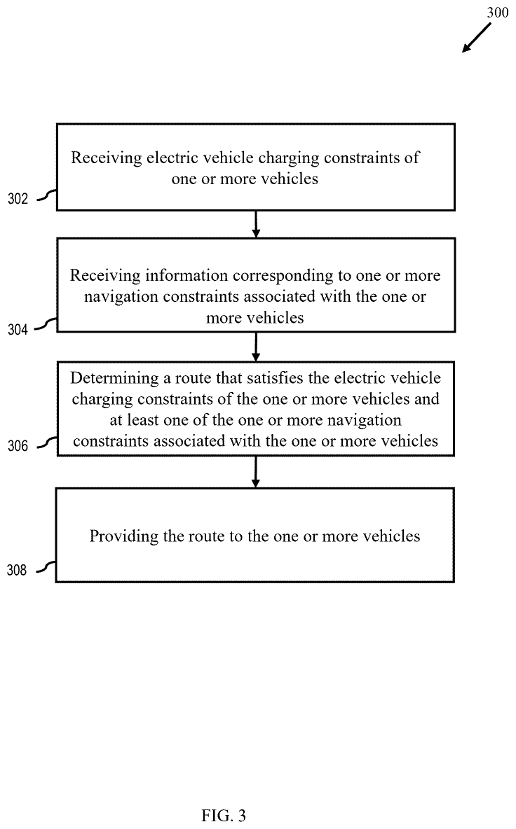

FIG. 2 is a diagram of the components of the data analysis system 103 of FIG. 1, according to one embodiment. By way of example, the data analysis system 103 includes one or more components for optimizing routes for vehicles according to the various embodiments described herein. It is contemplated that the functions of these components may be combined or performed by other components of equivalent functionality. In this embodiment, data analysis system 103 includes in input/output module 202, a memory module 204, and a processing module 206. The above presented modules and components of the data analysis system 103 can be implemented in hardware, firmware, software, or a combination thereof. Though depicted as a separate entity in FIG. 1, it is contemplated that the data analysis system 103 may be implemented as a module of any of the components of the system 100 (e.g., a component of the services platform 113, etc.). In another embodiment, one or more of the modules 202-206 may be implemented as a cloud-based service, local service, native application, or combination thereof. The functions of these modules are discussed with respect to FIG. 3 below.

FIG. 3 is a flowchart of an example method, in accordance with at least some of the embodiments described herein. Although the blocks in each figure are illustrated in a sequential order, the blocks may in some instances be performed in parallel, and/or in a different order than those described therein. Also, the various blocks may be combined into fewer blocks, divided into additional blocks, and/or removed based upon the desired implementation.

In addition, the flowchart of FIG. 3 shows the functionality and operation of one possible implementation of the present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include non-transitory computer-readable media that stores data for short periods of time, such as register memory, processor cache, or Random Access Memory (RAM), and/or persistent long term storage, such as read only memory (ROM), optical or magnetic disks, or compact-disc read only memory (CD-ROM), for example. The computer readable media may also be, or include, any other volatile or non-volatile storage systems. The computer readable medium may be considered a computer readable storage medium, a tangible storage device, or other article of manufacture, for example.

Alternatively, each block in FIG. 3 may represent circuitry that is wired to perform the specific logical functions in the process. An illustrative method, such as that shown in FIG. 3, may be carried out in whole or in part by a component or components in the cloud and/or system. However, it should be understood that the example methods may instead be carried out by other entities or combinations of entities (i.e., by other computing devices and/or combinations of computing devices), without departing from the scope of the invention. For example, functions of the method of FIG. 3 may be fully performed by a computing device (or components of a computing device such as one or more processors) or may be distributed across multiple components of the computing device, across multiple computing devices, and/or across a server.

Referring to FIG. 3, an example method 300 may include one or more operations, functions, or actions as illustrated by blocks 302-308. The blocks 302-308 may be repeated periodically or performed intermittently, or as prompted by a user, device, or system. In one embodiment, the method 300 is implemented in whole or in part by the data analysis system 103 of FIG. 1.

As shown by block 302, the method 300 includes, receiving electric vehicle charging constraints of one or more vehicles. In one example, the input/output module 202 of FIG. 2 is configured to receive electric vehicle charging constraints of one or more vehicles. In one embodiment, the electric vehicle charging constraints include the type of charger that the electric vehicle is capable of utilizing. In another embodiment, the electric vehicle charging constraints may include the charging profile associated with the electric vehicle. For example, the charging profile of an electric vehicle may include information that indicates the differences in required charging time based on the level charger (e.g., Level 1 EV charger, Level 2 EV charger, etc.) utilized. In another example, the charging profiles of the one or more electric vehicles include a set of instructions that an electric vehicle charger follows for optimal charging of the one or more batteries of a vehicle. In another example, the charging profiles may also include an electric vehicle charge start time, an initial battery state-of-charge (SOC), and a total charging time. In another example, the electric vehicle charging constraints include a real-time update of current charge levels associated with the one or more electric vehicles.

As shown by block 304, the method 300 also includes, receiving information corresponding to one or more navigation constraints associated with the one or more vehicles. In one example, the input/output module 202 of FIG. 2 is configured to receive information corresponding to one or more navigation constraints associated with the one or more vehicles. In one embodiment, the one or more navigation constraints may include the addresses of one or more destinations. In one scenario, a passenger of a vehicle may input the addresses via a user interface associated with the vehicle. By way of example, this may occur through a device coupled to the video or user equipment (e.g., mobile phone) that is in communication with the vehicle. In another embodiment, the one or more navigation constraints may include preferences related to the operation of the vehicle. For example, the one or more navigation constraints may include a preference of utilizing a freeway as opposed to a tollway. In another example, a user may request to not travel above or below a certain speed. In another embodiment, the one or more navigation constraints may include preferences related to another vehicle. For example, the one or more navigation constraints may include a preference to maintain a certain proximity to another vehicle while travelling along the route. In another embodiment, the one or more navigation constraints my include one or more points of interest that a user is interested in viewing along the route.

As shown by block 306, the method 300 also includes, determining a route that satisfies the electric vehicle charging constraints of the one or more vehicles and at least one of the one or more navigation constraints associated with the one or more vehicles. In one example, the processing module 206 of FIG. 2 is configured to determine a route that satisfies the electric vehicle charging constraints of the one or more vehicles and at least one of the one or more navigation constraints associated with the one or more vehicles. In one example, the processing module 206 is configured to communicate with one or more components of the system 100 of FIG. 1. For example, the processing module 206 may be configured to communicate via the input/output module 202 with the database 107, one or more of the content providers 111a-111n, and the services platform 113 in order to obtain data corresponding to the electric vehicle charging constraints and the one or more navigation constraints. In this example, the processing module 206 may receive information of nearby electric vehicle charge points along a route, the status associated with each electric vehicle charge point, and the type of chargers (alternating current chargers, direct current fast chargers, etc.) at each electric vehicle charge point. Continuing with this example, the processing module 206 may receive information pertaining to one or aspects associated with one or more roads along the route.

In one example, determining the route is based on an optimization of one or more of an arrival time at a destination and maintaining a predetermined proximity between the one or more vehicles. For example, the processing module 206 of FIG. 2. may be configured to calculate a route that enables both electric vehicles to charge at different types of chargers along the route. In this example, the processing module 206 may be configured to analyze the various electric vehicle charging constraints of each electric vehicle to ensure that both electric vehicles arrive at a destination by a certain time and maintain a predetermined proximity while traveling along the route.

As shown by block 308, the method 300 also includes, providing the route to the one or more vehicles. In one example, the input/output module 202 of FIG. 2 is configured to provide the route to the one or more vehicles. In one embodiment, the provided route is displayed in each of the one or more vehicles. In one scenario, any changes made to the route are reflected in real-time in both vehicles as well.

In one embodiment, the method 300 may further include, determining one or more aspects affecting the electric vehicle charging constraints. In this embodiment, the method 300 may further include, adjusting the determined route based on the one or more aspects. Continuing with this embodiment, the method 300 may further include, providing the adjusted determined route to the one or more vehicles. In one scenario, the aspects affecting the electric vehicle charging constraints may be associated with an event occurring while both electric vehicles are driving along the route. For example, a concert or a sporting event may be causing an influx of a large number of vehicles to be traveling or parked within one or more electric vehicle charge points that could be utilized by either of the two vehicles traveling along the route. In this example, the processing module 206 of FIG. 2 may be configured to provide a route that avoids one or more areas associated with the event to ensure that either of the two electric vehicles traveling along the route are able to utilize the electric vehicle charge points. In another scenario, the aspects that affect the electric vehicle charging constraints may be associated with weather along the route. In this scenario, the weather may affect the ability to utilize an electric vehicle charge point that is not enclosed in a structure (e.g., a parking structure). Continuing with this scenario, the processing module 206 may be configured to adjust the route to include locations with electric vehicle charge points that are less likely to be affected by weather conditions.

In another embodiment, the method 300 may further include, receiving an input from the one or more vehicles, wherein the input is a change to the route. In this embodiment, the method 300 may further include, determining a new route based on the received input. Continuing with this embodiment, the method 300 may further include, providing the new route to the one or more vehicles. In one scenario, a passenger in either of two electric vehicles may make a change to the route by searching for a place to stop (e.g., a restaurant, a rest area, etc.). In this scenario, the passenger may make the change to the route utilizing a touch interface of the electric vehicle or via one or more inputs corresponding to user equipment associated with the passenger. Continuing with this scenario, the processing module 206 of FIG. 2 may be configured to provide the new route to the second electric vehicle based on the received input from the first electric vehicle. In one example, the new route may be accompanied by an alert in the second electric vehicle explaining why the route has been changed. For example, the alert may include information that the request to change the route has come from the first electric vehicle.

In another embodiment, the method 300 may further include, receiving a request to designate a given vehicle of the one or more vehicles as a lead vehicle along the route. In this embodiment, the method 300 may further include, determining a new route based on the designation of the given vehicle as the lead vehicle. Continuing with this embodiment, the method 300 may further include, providing the new route to the one or more vehicles. In one example, the new route according to the designation of the given vehicle as the lead vehicle may be based on analysis of electric vehicle charging constraints associated with the lead vehicle. For example, if the lead vehicle has a battery charge level of less than 30%, then the determined new route may include a stop at the nearest electric vehicle charge point that can accommodate the lead vehicle. In one scenario, when the given vehicle of the one or more vehicles is the lead vehicle, the other vehicles will follow a route that is determined for the lead vehicle. For example, if a passenger associated with the lead vehicle makes a change to the route, the new route will automatically be provided to the other vehicles. In one embodiment, the designation of the lead vehicle may be selected by passengers in the other vehicles as well.

In another embodiment, the method 300 may further include, generating one or more alerts based on one or more operating parameters in the lead vehicle. In this embodiment, the method 300 may further include, providing the one or more alerts to the other one or more vehicles. In one example, the alerts may be provided to the other one or more vehicles via one or more interfaces associated with each of the other one or more vehicles. By way of example, the alert may also be relayed to one or more communication devices associated with passengers of the other one or more vehicles.

In another embodiment, the method 300 may further include, monitoring electric charge consumption in the one or more vehicles. In this embodiment, the method 300 may further include, determining electric charge in at least one of the one or more vehicles has satisfied a charging threshold. In this embodiment, the method 300 may further include, determining one or more electric vehicle charge points for charging at least one of the one or more vehicles. In this embodiment, the method 300 may further include, determining a modified route to include a stop at the one or more electric vehicle charge points. Continuing with this embodiment, the method 300 may further include, providing the new route to the one or more vehicles. In one example, satisfying the charging threshold may mean that one or more vehicles are either below or above the threshold.

In another embodiment, the method 300 may further include, determining a first route and a second route for the one or more vehicles, wherein the first route and the second route converge into a merged route of the first route and the second route. In this embodiment, the method 300 may further include, providing the first route to a first vehicle of the one or more vehicles. Continuing with this embodiment, the method 300 may further include, providing the second route to a second vehicle of the one or more vehicles. In one example, the first route may be associated with a specific electric vehicle charge point that is necessary for one of the vehicles. Continuing with this example, the second route may also be associated with a different electric vehicle charge point that is not found along the first route.

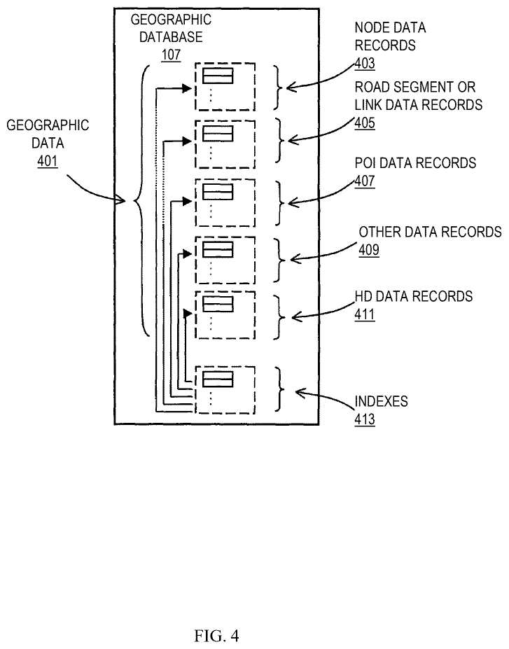

FIG. 4 is a diagram of the geographic database 107 of system 100, according to exemplary embodiments. In the exemplary embodiments, the information generated by the map platform 101 can be stored, associated with, and/or linked to the geographic database 107 or data thereof. In one embodiment, the geographic database 107 includes geographic data 401 used for (or configured to be compiled to be used for) mapping and/or navigation-related services, such as for personalized route determination, according to exemplary embodiments. For example, the geographic database 107 includes node data records 403, road segment data records 405, POI data records 407, other data records 409, high-definition (HD) data records 411, and indexes 413, for example. It is envisioned that more, fewer or different data records can be provided.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions, models, routes, etc. Accordingly, the terms polygons and polygon extrusions/models as used herein can be used interchangeably.

In one embodiment, the following terminology applies to the representation of geographic features in the geographic database 107.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 107 follows certain conventions. For example, links do not cross themselves and do not cross each other except at a node or vertex. Also, there are no duplicated shape points, nodes, or links. Two links that connect each other have a common node or vertex. In the geographic database 107, overlapping geographic features are represented by overlapping polygons. When polygons overlap, the boundary of one polygon crosses the boundary of the other polygon. In the geographic database 107, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

In one embodiment, the geographic database 107 is presented according to a hierarchical or multi-level tile projection. More specifically, in one embodiment, the geographic database 107 may be defined according to a normalized Mercator projection. Other projections may be used. In one embodiment, a map tile grid of a Mercator or similar projection can a multilevel grid. Each cell or tile in a level of the map tile grid is divisible into the same number of tiles of that same level of grid. In other words, the initial level of the map tile grid (e.g., a level at the lowest zoom level) is divisible into four cells or rectangles. Each of those cells are in turn divisible into four cells, and so on until the highest zoom level of the projection is reached.

In one embodiment, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. In one embodiment, each cell is divided into four rectangles and numbered by concatenating the parent tile ID and the new tile position. A variety of numbering schemes also is possible. Any number of levels with increasingly smaller geographic areas may represent the map tile grid. Any level (n) of the map tile grid has 2(n+1) cells. Accordingly, any tile of the level (n) has a geographic area of A/2(n+1) where A is the total geographic area of the world or the total area of the map tile grids. Because of the numbering system, the exact position of any tile in any level of the map tile grid or projection may be uniquely determined from the tile ID.

In one embodiment, the system 100 may identify a tile by a quadkey determined based on the tile ID of a tile of the map tile grid. The quadkey, for example, is a one-dimensional array including numerical values. In one embodiment, the quadkey may be calculated or determined by interleaving the bits of the row and column coordinates of a tile in the grid at a specific level. The interleaved bits may be converted to a predetermined base number (e.g., base 10, base 4, hexadecimal). In one example, leading zeroes are inserted or retained regardless of the level of the map tile grid in order to maintain a constant length for the one-dimensional array of the quadkey. In another example, the length of the one-dimensional array of the quadkey may indicate the corresponding level within the map tile grid. In one embodiment, the quadkey is an example of the hash or encoding scheme of the respective geographical coordinates of a geographical data point that can be used to identify a tile in which the geographical data point is located.

In exemplary embodiments, the road segment data records 405 are links or segments representing roads, streets, or paths, as can be used in the calculated route or recorded route information for determination of one or more personalized routes, according to exemplary embodiments. The node data records 403 are end points or vertices (such as intersections) corresponding to the respective links or segments of the road segment data records 405. The road segment data records 405 and the node data records 403 represent a road network, such as used by vehicles, cars, and/or other entities. Alternatively, the geographic database 107 can contain path segment and node data records or other data that represent pedestrian paths or areas in addition to or instead of the vehicle road record data, for example. In one embodiment, the road or path segments can include an altitude component to extend to paths or road into three-dimensional space (e.g., to cover changes in altitude and contours of different map features, and/or to cover paths traversing a three-dimensional airspace).

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 107 can include data about the POIs and their respective locations in the POI data records 407. In one example, the POI data records 407 may include the hours of operation for various businesses. The geographic database 107 can also include data about places, such as cities, towns, or other communities, and other geographic features, such as bodies of water, mountain ranges, etc. Such place or feature data can be part of the POI data records 407 or can be associated with POIs or POI data records 407 (such as a data point used for displaying or representing a position of a city).

In one embodiment, other data records 409 include cartographic (“carto”) data records, weather data, traffic data, routing data, and maneuver data. In one example, the other data records 409 include data that is associated with certain POIs, roads, or geographic areas. In one example, the data is stored for utilization by a third-party. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using the point-based map matching embodiments describes herein), for example.

In one example, the other data records 409 include weather data records such as weather data reports. In this example, the weather data records can be associated with any of the map features stored in the geographic database 107 (e.g., a specific road or link, node, intersection, area, POI, etc.) on which the weather data was collected. In another example, the other data records 409 include traffic data records such as traffic data reports. In this example, the traffic data records can be associated with any of the map features stored in the geographic database 107 (e.g., a specific road or link, node, intersection, area, POI, etc.) on which the traffic data was collected.

In one embodiment, the other data records 409 include electric vehicle charging point data records. For example, the electric vehicle charging point data records can be associated with any of the map features stored in the geographic database 107 (e.g., a specific road or link, node, intersection, area, POI, etc.) on which data was collected. In one example, the electric vehicle charging point data records includes spatial and temporal elements that correspond to one or more map features stored in the geographic database 107. In another example, the electric vehicle charging point data records includes one or more recommended activities of an occupant of a vehicle.

In one embodiment, the geographic database 107 may also include point data records for storing the point data, map features, as well as other related data used according to the various embodiments described herein. In addition, the point data records can also store ground truth training and evaluation data, machine learning models, annotated observations, and/or any other data. By way of example, the point data records can be associated with one or more of the node data records 403, road segment data records 405, and/or POI data records 407 to support verification, localization or visual odometry based on the features stored therein and the corresponding estimated quality of the features. In this way, the point data records can also be associated with or used to classify the characteristics or metadata of the corresponding records 403, 405, and/or 407.

As discussed above, the HD data records 411 may include models of road surfaces and other map features to centimeter-level or better accuracy. The HD data records 411 may also include models that provide the precise lane geometry with lane boundaries, as well as rich attributes of the lane models. These rich attributes may include, but are not limited to, lane traversal information, lane types, lane marking types, lane level speed limit information, and/or the like. In one embodiment, the HD data records 411 may be divided into spatial partitions of varying sizes to provide HD mapping data to vehicles and other end user devices with near real-time speed without overloading the available resources of these vehicles and devices (e.g., computational, memory, bandwidth, etc. resources). In some implementations, the HD data records 411 may be created from high-resolution 3D mesh or point-cloud data generated, for instance, from LiDAR-equipped vehicles. The 3D mesh or point-cloud data may be processed to create 3D representations of a street or geographic environment at centimeter-level accuracy for storage in the HD data records 411.

In one embodiment, the HD data records 411 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

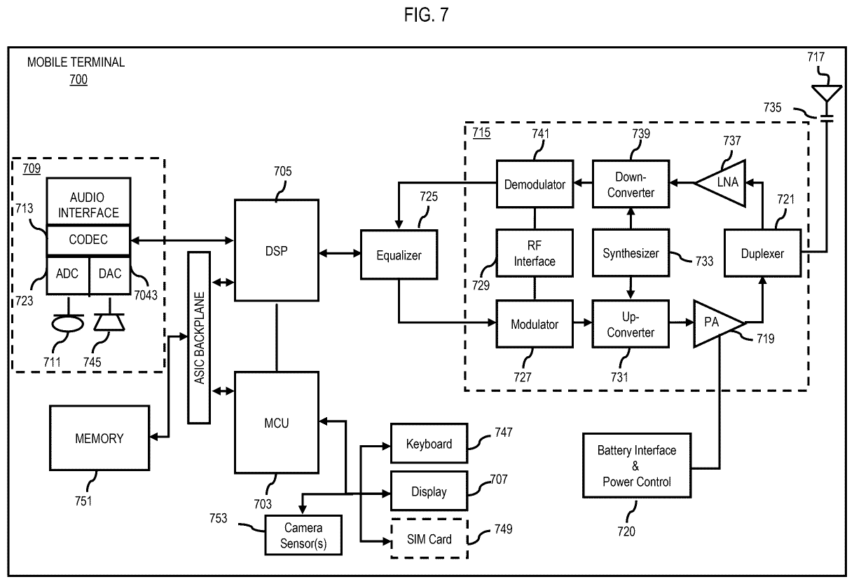

The indexes 413 in FIG. 7 may be used improve the speed of data retrieval operations in the geographic database 107. Specifically, the indexes 413 may be used to quickly locate data without having to search every row in the geographic database 107 every time it is accessed. For example, in one embodiment, the indexes 413 can be a spatial index of the polygon points associated with stored feature polygons.

The geographic database 107 can be maintained by the one or more content providers 111a-111n in association with the services platform 113 (e.g., a map developer). The map developer can collect geographic data to generate and enhance the geographic database 107. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 107 can be a master geographic database stored in a format that facilitates updating, maintenance, and development. For example, the master geographic database 107 or data in the master geographic database 107 can be in an Oracle spatial format or other spatial format (for example, accommodating different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for optimizing routes for vehicles may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

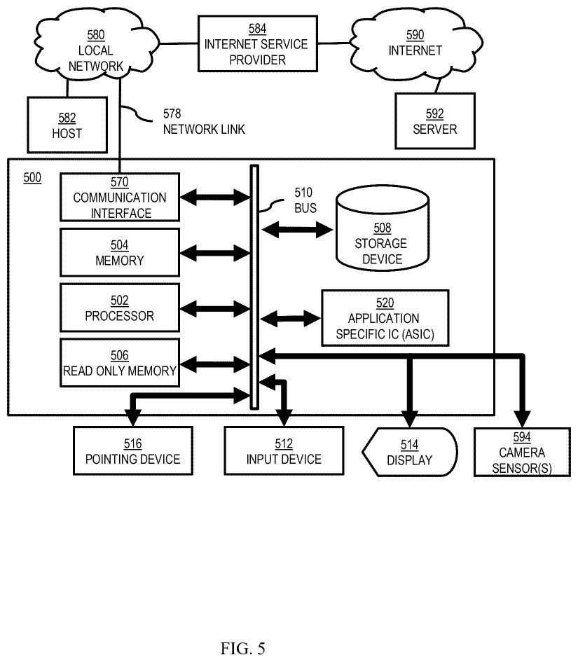

FIG. 5 illustrates a computer system 500 upon which an embodiment may be implemented. Computer system 500 is programmed (e.g., via computer program code or instructions) to provide information for optimizing routes for vehicles as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 510 includes one or more parallel conductors of information so that information is transferred quickly among devices coupled to the bus 510. One or more processors 502 for processing information are coupled with the bus 510.

A processor 502 performs a set of operations on information as specified by computer program code related to optimizing routes for vehicles. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations includes bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 504 coupled to bus 510. The memory 504, such as a random-access memory (RAM) or other dynamic storage device, stores information including processor instructions for optimizing routes for vehicles. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for optimizing routes for vehicles, is provided to the bus 510 for use by the processor from an external input device 512, such as a keyboard containing alphanumeric keys operated by a human user, or a sensor. A sensor detects conditions in its vicinity and transforms those detections into physical expression compatible with the measurable phenomenon used to represent information in the computer system 500. Other external devices coupled to bus 510, used primarily for interacting with humans, include a display 514, such as a cathode ray tube (CRT) or a liquid crystal display (LCD), or plasma screen or printer for presenting text or images, and a pointing device 516, such as a mouse or a trackball or cursor direction keys, or motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of application specific ICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

The computer system 500 may also include one or more instances of a communications interface 570 coupled to bus 510. The communication interface 570 may provide a one-way or two-way communication coupling to a variety of external devices that operate with their own processors, such as printers, scanners and external disks. In addition, the communication interface 570 may provide a coupling to a local network 580, by way of a network link 578. The local network 580 may provide access to a variety of external devices and systems, each having their own processors and other hardware. For example, the local network 580 may provide access to a host 582, or an internet service provider 584, or both, as shown in FIG. 5. The internet service provider 584 may then provide access to the Internet 590, in communication with various other servers 592.

The computer system 500 also includes one or more instances of a communication interface 570 coupled to bus 510. Communication interface 570 provides a one-way or two-way communication coupling to a variety of external devices that operate with their own processors, such as printers, scanners and external disks. In general, the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, the communication interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, the communication interface 570 may be a local area network (LAN) card to provide a data communication connection to a compatible LAN, such as Ethernet. Wireless links may also be implemented. For wireless links, the communication interface 570 sends or receives or both sends and receives electrical, acoustic or electromagnetic signals, including infrared and optical signals, that carry information streams, such as digital data. For example, in wireless handheld devices, such as mobile telephones like cell phones, the communication interface 570 includes a radio band electromagnetic transmitter and receiver called a radio transceiver. In certain embodiments, the communication interface 570 enables connection to the communication network 115 of FIG. 1 for providing information for optimizing routes for vehicles.

The term computer-readable medium is used herein to refer to any medium that participates in providing information to processor 502, including instructions for execution. Such a medium may take many forms, including, but not limited to, non-volatile media, volatile media and transmission media. Non-volatile media include, for example, optical or magnetic disks, such as storage device 508. Volatile media include, for example, dynamic memory 504. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

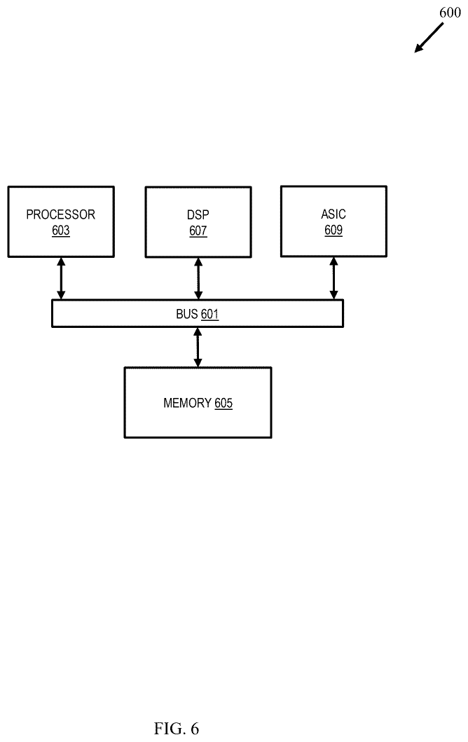

FIG. 6 illustrates a chip set 600 upon which an embodiment may be implemented. The chip set 600 is programmed for optimizing routes for vehicles as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively, or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to perform specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the steps described herein to provide information for optimizing routes for vehicles. The memory 605 also stores the data associated with or generated by the execution of the inventive steps.

FIG. 7 is a diagram of exemplary components of a mobile terminal 700 (e.g., a mobile device, vehicle, and/or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back end encompasses all of the base-band processing circuitry. Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile station functions that offer automatic contact matching. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G networks, code division multiple access (CDMA), wireless fidelity (WiFi), satellite, and the like.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, other mobile phone or a landline connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703—which can be implemented as a Central Processing Unit (CPU) (not shown).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile station 1001 to provide information for optimizing routes for vehicles. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the station. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 751 may be, but not limited to, a single memory, CD, DVD, ROM, RAM, EEPROM, optical storage, or any other non-volatile or non-transitory storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The SIM card 749 also contains a memory for storing a personal telephone number registry, text messages, and user specific mobile station settings.

While features have been described in connection with a number of embodiments and implementations, various obvious modifications and equivalent arrangements, which fall within the purview of the appended claims are envisioned. Although features are expressed in certain combinations among the claims, it is contemplated that these features can be arranged in any combination and order.

We (I) claim:

1. A method comprising:
receiving electric vehicle charging constraints of one or more vehicles;
receiving information corresponding to one or more navigation constraints associated with the one or more vehicles;
determining a route that satisfies the electric vehicle charging constraints of the one or more vehicles and at least one of the one or more navigation constraints associated with the one or more vehicles; and
providing the route to the one or more vehicles.

2. The method of claim 1, further comprising:
determining one or more aspects affecting the electric vehicle charging constraints;
adjusting the determined route based on the one or more aspects; and
providing the adjusted determined route to the one or more vehicles.

3. The method of claim 1, further comprising:
receiving an input from the one or more vehicles, wherein the input is a change to the route;
determining a new route based on the received input; and
providing the new route to the one or more vehicles.

4. The method of claim 1, further comprising:
receiving a request to designate a given vehicle of the one or more vehicles as a lead vehicle along the route;
determining a new route based on the designation of the given vehicle as the lead vehicle; and
providing the new route to the one or more vehicles.

5. The method of claim 4, further comprising:
generating one or more alerts based on one or more operating parameters in the lead vehicle; and
providing the one or more alerts to the other one or more vehicles.

6. The method of claim 2,
monitoring electric charge consumption in the one or more vehicles;
determining electric charge in at least one of the one or more vehicles has satisfied a charging threshold;
determining one or more electric vehicle charge points for charging the at least one of the one or more vehicles;
determining a modified route to include a stop at the one or more electric vehicle charge points; and
providing the new route to the one or more vehicles.

7. The method of claim 1, wherein determining the route is based on an optimization of one or more of an arrival time at a destination and maintaining a predetermined proximity between the one or more vehicles.

8. The method of claim 1, further comprising:
determining a first route and a second route for the one or more vehicles, wherein the first route and the second route converge into a merged route of the first route and the second route;
providing the first route to a first vehicle of the one or more vehicles; and
providing the second route to a second vehicle of the one or more vehicles.

9. A non-transitory computer-readable storage medium carrying one or more sequences of one or more instructions which, when executed by one or more processors, cause an apparatus to perform the following steps:
receiving electric vehicle charging constraints of one or more vehicles;
receiving information corresponding to one or more navigation constraints associated with the one or more vehicles;
determining a route that satisfies the electric vehicle charging constraints of the one or more vehicles and at least one of the one or more navigation constraints associated with the one or more vehicles; and
providing the route to the one or more vehicles.

10. The non-transitory computer-readable storage medium of claim 9, wherein providing the route to the one or more vehicles further includes:
determining one or more aspects affecting the electric vehicle charging constraints;
adjusting the determined route based on the one or more aspects; and
providing the adjusted determined route to the one or more vehicles.

11. The non-transitory computer-readable storage medium of claim 9, wherein providing the route to the one or more vehicles further includes:
receiving an input from the one or more vehicles, wherein the input is a change to the route;
determining a new route based on the received input; and
providing the new route to the one or more vehicles.

12. The non-transitory computer-readable storage medium of claim 9, wherein providing the route to the one or more vehicles further includes:
receiving a request to designate a given vehicle of the one or more vehicles as a lead vehicle along the route;
determining a new route based on the designation of the given vehicle as the lead vehicle; and
providing the new route to the one or more vehicles.

13. The non-transitory computer-readable storage medium of claim 9, wherein the one or more sequences of the one or more instructions which, when executed by the one or more processors, cause the apparatus to perform the following steps:
generating one or more alerts based on one or more operating parameters in the lead vehicle; and
providing the one or more alerts to the other one or more vehicles.

14. The non-transitory computer-readable storage medium of claim 10, wherein providing the route to the one or more vehicles further includes further includes:
monitoring electric charge consumption in the one or more vehicles;
determining electric charge in at least one of the one or more vehicles has satisfied a charging threshold;
determining one or more electric vehicle charge points for charging the at least one of the one or more vehicles;
determining a modified route to include a stop at the one or more electric vehicle charge points; and
providing the new route to the one or more vehicles.

15. The non-transitory computer-readable storage medium of claim 9, wherein determining the route is based on an optimization of one or more of an arrival time at a destination and maintaining a predetermined proximity between the one or more vehicles.

16. The non-transitory computer-readable storage medium of claim 9, wherein providing the route to the one or more vehicles further includes:
determining a first route and a second route for the one or more vehicles, wherein the first route and the second route converge into a merged route of the first route and the second route;
providing the first route to a first vehicle of the one or more vehicles; and
providing the second route to a second vehicle of the one or more vehicles.

17. A system comprising at least one processor and at least one non-transitory memory including computer program code instructions, the computer program code instructions configured to, when executed, cause the system to:
receive electric vehicle charging constraints of one or more vehicles;
receive information corresponding to one or more navigation constraints associated with the one or more vehicles;
determine a route that satisfies the electric vehicle charging constraints of the one or more vehicles and at least one of the one or more navigation constraints associated with the one or more vehicles; and
provide the route to the one or more vehicles.

18. The system of claim 17, wherein the computer program code instructions configured to, when executed, cause the system to:
determine one or more aspects affecting the electric vehicle charging constraints;
adjust the determined route based on the one or more aspects; and
provide the adjusted determined route to the one or more vehicles.

19. The system of claim 17, wherein the computer program code instructions configured to, when executed, cause the system to:
receive an input from the one or more vehicles, wherein the input is a change to the route;
determine a new route based on the received input; and
provide the new route to the one or more vehicles.

20. The system of claim 17, wherein the computer program code instructions configured to, when executed, cause the system to:
monitor electric charge consumption in the one or more vehicles;
determine electric charge in at least one of the one or more vehicles has satisfied a charging threshold;
determine one or more electric vehicle charge points for charging the at least one of the one or more vehicles;
determine a modified route to include a stop at the one or more electric vehicle charge points; and
provide the new route to the one or more vehicles.
